(19) United States
(12) Patent Application Publication
(10) Pub. No.: US 2010/0073142 A1
(43) Pub. Date: Mar. 25, 2010

(54) SAW BASED CHIPLESS PASSIVE RFID TAG USING CELLULOSE PAPER AS SUBSTRATE AND METHOD OF MANUFACTURING THE CELLULOSE PAPER

(75) Inventor: Jae Hwan Kim, Incheon (KR)

Correspondence Address: TUROCY & WATSON, LLP, 127 Public Square, 57th Floor, Key Tower, CLEVELAND, OH, 44114, US

(73) Assignee: INHA-INDUSTRY PARTNERSHIP INSTITUTE, Nam-gu, Incheon (KR)

(21) Appl. No.: 12/513,400

(22) PCT Filed: Dec. 13, 2006
(86) PCT No.: PCT/KR06/05429

§ 371 Date: May 4, 2009

(30) Foreign Application Priority Data
Nov. 7, 2006 (KR) 10-2006-0109471

(51) Int. Cl. H04Q 5/22

(52) U.S. Cl. 340/10.4

(57) ABSTRACT

A SAW based chipless passive tag includes a dipole antenna, a SAW based IDT, and a plurality of reflectors, which are provided on a cellulose paper, so that a reader can read iden [symbol] tification information of an object.

### TECHNICAL FIELD

The present invention relates to an RFID, and more particularly, to a SAW based chipless passive RFID tag.

### BACKGROUND ART

An RFID system is generally composed of a tag, a reader, and a computer for processing data. The reader processes and stores a signal by transmitting microwaves to the tag and receiving microwaves from the tag, and the tag stores information of an object to which the tag is attached.

The tag may be classified into a chip type and a SAW (Surface Acoustic Wave) type, and also may be classified into an active type and a passive type, depending upon whether the tag itself has a power. An electromagnetic wave is utilized so as to remotely recognize the tag. The RFID system adopts technology using electromagnet or electrostatic coupling in radio frequencies of electromagnetic spectrum portion to remotely identify objects, such as things, animals and people. The information signal radiated from a chip, which stores therein information of the object and which the tag is attached to, via an antenna of the tag is remotely read by a reader, and then is sent to the computer. Therefore, all information of the object to which the tag is attached can be automatically identified and tracked anywhere and any time.

Such an RFID can replace a conventional barcode system, and serves as critical technology to realize ubiquitous. The RFID is broadly applied to various industrial fields such as a distribution industry including storage, transportation and tracing of goods, electronic libraries, electronic payment, security and the like.

When the reader sends the microwaves to the tag, the RFID is energized by the received microwaves. The energized tag sends the stored information to the reader. In this instance, the passive RFID is energized by the received microwaves, while the active RFID is energized by a built-in battery.

The RFID utilizes frequency bands of 135 KHz, 13.56 MHz, 860 to 960 MHz, 2.45 GHz and the like. As the frequency is higher, the recognition of the RFID is performed at higher speed and becomes sensitive to environments, and the size of the tag is reduced.

As the passive tag, the chip tag has been developed by Hitachi, Alien Technology or the like, while the SAW based chipless tag has been developed by RFSAW or the like. In particular, the SAW based tag includes an IDT (Interdigit Transducer) having several metal thin film electrodes and mounted on a surface of a piezoelectric material to generate surface acoustic waves by using a converse piezoelectric effect and a direct piezoelectric effect.

The IDT includes metal electrodes which are successively arranged in parallel on the surface of a piezoelectric substrate and have the same pattern as an impulse signal. In this instance, an electric signal being applied to the IDT is an RF (Radio Frequency) or microwave signal in the range of several MHz to several GHz. The electric signal has a propagation speed of 3*10⁸ m/s, but the speed of the surface acoustic wave is in the range of about 2500 to 300 m/s, which is lower than the propagation speed.

If an AC voltage signal is applied to the IDT from the reader, an electric field is generated between adjacent electrodes having different polarities, and the surface of the substrate is deformed by the converse piezoelectric effect of the substrate, so that the surface acoustic wave is propagated. In this instance, reflectors of metal bars which are installed at regular intervals reflect the propagated surface acoustic wave. The phase of the reflected wave is varied depending upon the position of the reflector. The reflected surface acoustic wave is converted into an electric signal by the direct piezoelectric effect of the IDT, and then is transmitted to the reader through the antenna. The transmitted signal represents various types of pulse waveforms according to the positions of the reflectors. The information of the detected signal is read through its amplitude, time delay and phase change.

### DISCLOSURE OF INVENTION

### Technical Problem

In view of the prior art, the present invention relates to technology for remotely recognizing information of an object. However, a conventional RFID tag includes a chip or antenna inserted between papers or plastic films. Because the chip and plastic are not decomposed by biological action, they become industrial waste. Also, there are problems that it is difficult to perform printing on the plastic, and the conventional substrate composed of chips, plastic, and other substances increases the manufacturing cost thereof.

### Technical Solution

Accordingly, the present invention has been made to solve the above-mentioned problems occurring in the prior art, and an object of the present invention is to provide an RFID tag including a cellulose paper as a substrate and a SAW instead of a chip, so that the RFID can be made of inexpensive environment-friendly material.

Additional advantages, objects, and features of the invention will be set forth in part in the description which follows and in part will become apparent to those having ordinary skill in the art upon examination of the following or may be learned from practice of the invention.

In order to accomplish these objects, there is provided a chipless passive tag, according to an aspect of the present invention, which comprises an antenna for receiving a microwave from a reader; a SAW based IDT for converting an electric signal into a mechanical signal; and a plurality of reflectors for reflecting a surface acoustic wave. The antenna, the SAW based IDT and the reflectors are mounted on a substrate made of cellulose paper.

In another aspect of the present invention, there is provided a method of manufacturing a cellulose paper, which comprises solving cellulose pulp with a solvent to make a solution of micro fibers; forming a thin film through spin-coating or extruding, in which the micro fibers are arranged in a regular direction; and removing the solvent from the thin film.

### Advantageous Effects

Since the RFID tag of the present invention is made of the cellulose paper, the tag is decomposed by biological action. It is environmentally friendly material and is not harmful to a human body. The passive RFID tag which does not require a battery can be manufactured by using a piezoelectric effect of cellulose, and its manufacturing cost is lowered by use of the paper.

### BRIEF DESCRIPTION OF THE DRAWINGS

The above and other objects, features and advantages of the present invention will be more apparent from the following detailed description taken in conjunction with the accompanying drawings, in which:

FIG. 1 is a view schematically illustrating an RFID tag according to an embodiment of the present invention.

### BEST MODE FOR CARRYING OUT THE INVENTION

Hereinafter, preferred embodiments of the present invention will be described in detail with reference to the accompanying drawings.

A cellulose paper for use in the present invention mainly consists of cellulose, with cellulose micro fibers being regularly arraigned. A common cellulose paper is a paper having micro fibers which are randomly arranged. The paper of the present invention is manufactured to have a predetermined orientation, which can be used as a material of the RFID.

A method of manufacturing the paper according to a first embodiment of the present invention includes solving cellulose pulp with a solvent, such as NaOH, DMAC (N,N-dimethylacetamide) or NMMO (N-methylmorpholine-N-oxide), to make a cellulose solution, and spin-coating or extruding the cellulose solution to make a thin film. In case of the spin coating, the micro fibers are arranged in a regular direction by a centrifugal force. In case of the extrusion, the micro fibers are arranged in a regular direction due to a mechanical effect caused by a rolling direction and applied tension. A solvent is removed by reacting the formed cellulose film with water to reproduce the original cellulose, thereby manufacturing the cellulose paper. Electric polarization may be used to arrange the cellulose direction in further regular direction. More specifically, if the cellulose is applied with a high AC or DC electric field in a longitudinal or widthwise direction, the cellulose fibers are arranged in further regular direction according to the applied electric field.

According to a second embodiment of the present invention, carbon nano-tubes are mixed in a cellulose solution to form a cellulose film, in order for the selective performance of a cellulose paper having fibers which are arranged in a regular direction. The cellulose paper having various properties can be manufactured according to amount of the carbon nano-tubes to be mixed, a processing method of carbon nano-tubes, and a kind of the carbon nano-tube. For example, if the cellulose fibers and the carbon nano-tubes are arranged in a regular direction by mixing the carbon nano-tubes of 0.1 to 0.5% with the cellulose solution, the cellulose paper is suitable for a sensor material. By utilizing the property that electric conductivity and the heat conductivity are increased as more carbon nano-tubes are put in, various kinds of cellulose papers can selectively be manufactured, if necessary.

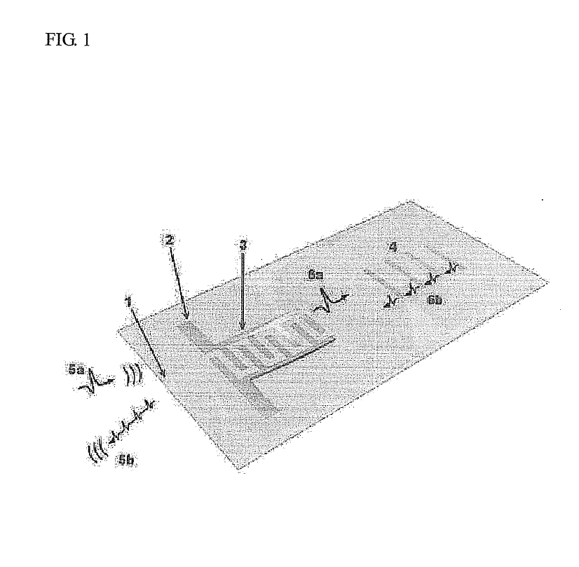

As shown in FIG. 1, a dipole antenna 2, a SAW based IDT 3 and plural reflectors 4 are provided on a cellulose paper 1 according to one embodiment to manufacture an RFID tag. When a reader (not shown) transmits a microwave pulse 5a, the pulse wave is transmitted to the IDT 3 via the antenna 2. The pulse generates an incident surface acoustic wave 6a due to a piezoelectric effect of the cellulose paper according to the present invention, and the surface acoustic wave is reflected by the reflectors 4. The surface acoustic wave 6b is reflected at various types according to the pattern of the reflectors 4. When the reflected surface acoustic wave meets the IDT again, the surface acoustic wave is converted into wave by the piezoelectric effect, and then is sent via the antenna, which is detected by the RFID reader. Information of a product attached with the tag is obtained from the detected signal by using amplitude, time deference, phase change and the like.

The amount of information is varied depending upon the number of reflectors which are positioned away from the IDT. For example, if six reflectors are installed, information of 2⁶=64 bits can be created, which is apparent to those skilled in the art.

Although preferred embodiments of the present invention have been described for illustrative purposes, those skilled in the art will appreciate that various modifications, additions and substitutions are possible, without departing from the scope and spirit of the invention as disclosed in the accompanying claims.

### INDUSTRIAL APPLICABILITY

The RFID can replace a conventional barcode system, and serves as critical technology to realize ubiquitous. The RFID is broadly applied to diverse industrial fields such as a distribution industry comprising storage, transportation and tracing of goods, electronic libraries, electronic payment, security and the like. The tag of the present invention can be preferably utilized in the RFID system.

1. A chipless passive tag comprising:
an antenna for receiving a microwave from a reader;
an SAW based IDT for converting an electric signal into a mechanical signal; and
a plurality of reflectors for reflecting a surface acoustic wave; wherein the antenna, the SAW based IDT and the reflectors are mounted on a substrate made of a cellulose paper.

2. The chipless passive tag as claimed in claim 1, wherein the reflectors are spaced apart from the SAW based IDT at predetermined intervals, and the number and the shape of reflectors are selected according to stored information.

3. The chipless passive tag as claimed in claim 1, wherein the cellulose paper has micro fibers arranged in a regular direction.

4. A method of manufacturing a cellulose paper, comprising:
solving cellulose pulp with a solvent to make a solution of micro fibers;
forming a thin film through spin-coating or extruding, in which the micro fibers are arranged in a regular direction; and
removing the solvent from the thin film.

5. The method as claimed in claim 4, wherein the solvent comprises NaOH, DMAC (N,N-dimethylacetamide) and NMMO (N-methylmorpholine-N-oxide).

6. The method as claimed in claim 4, further comprising improving an orientation of the micro fibers by using electric polarization.

7. The method as claimed in claim 4, further comprising mixing the solution of the micro fibers with carbon nano-tubes.

8. An RFID system comprising a substrate using an RFID tag and a cellulose paper as set forth in claim 1.

9. An RFID system comprising a substrate using an RFID tag and a cellulose paper as set forth in claim 2.

10. An RFID system comprising a substrate using an RFID tag and a cellulose paper as set forth in claim 3.

11. An RFID system comprising a substrate using an RFID tag and a cellulose paper as set forth in claim 4.

12. An RFID system comprising a substrate using an RFID tag and a cellulose paper as set forth in claim 5.

13. An RFID system comprising a substrate using an RFID tag and a cellulose paper as set forth in claim 6.

14. An RFID system comprising a substrate using an RFID tag and a cellulose paper as set forth in claim 7.
